(19) United States
(12) Patent Application Publication
(10) Pub. No.: US 2017/0346402 A1
(43) Pub. Date: Nov. 30, 2017

(54) SYNCHRONOUS RECTIFICATION DC/DC CONVERTER

(71) Applicant: ROHM CO., LTD., Ukyo-ku (JP)

(72) Inventors: Tsutomu ISHINO, Ukyo-ku (JP); Tetsuro HASHIMOTO, Ukyo-ku (JP)

(21) Appl. No.: 15/604,006

(22) Filed: May 24, 2017

(30) Foreign Application Priority Data
May 24, 2016 (JP) 2016-103559

(51) Int. Cl. H02M 3/158; H02M 1/08; H02M 1/00

(52) U.S. Cl. CPC H02M 3/1588; H02M 1/083; H02M 2001/0009

(57) ABSTRACT

A pulse modulator generates a pulse signal, such that an output signal of a DC/DC converter approaches a target value. When a detection value of a coil current of the DC/DC converter crosses a threshold for zero crossing, a reverse flow detection circuit asserts a reverse flow detection signal and turns off a synchronous rectification transistor of the DC/DC converter. An optimizer controls an operation parameter of the reverse flow detection circuit, on the basis of a cycle of the pulse signal.

### CROSS-REFERENCE TO RELATED APPLICATIONS

The present invention claims priority under 35 U.S.C. §119 to Japanese Patent Application No. 2016-103559, filed May 24, 2016, the entire contents of which are incorporated herein by reference.

### BACKGROUND OF THE INVENTION

### 1. Field of the Invention

The present invention relates to a DC/DC converter (switching regulator).

### 2. Description of the Related Art

Recently, a liquid crystal driver requiring a power supply voltage higher than a battery voltage or various processors requiring a power supply voltage lower than the battery voltage are mounted on an electronic apparatus such as a mobile phone terminal and a tablet personal computer (PC). To supply appropriate power supply voltages to these devices, a DC/DC converter is used.

FIG. 1 is a block diagram of a synchronous rectification step-down DC/DC converter 100r. The DC/DC converter 100r receives a direct-current (DC) input voltage V_{IN} by an input terminal P1, generates an output voltage V_{OUT} stabilized to a predetermined target value V_{OUT(REF)}, and supplies the output voltage V_{OUT} to a load connected to an output terminal P2.

The DC/DC converter 100r includes a switching transistor M1, a synchronous rectification transistor M2, an inductor L1, an output capacitor C1, and a controller 200. The controller 200 generates a pulse signal in which at least one of a duty ratio (pulse width) and a switching frequency is adjusted such that the output voltage V_{OUT} approaches the target value V_{OUT(REF)} and switches the switching transistor M1 and the synchronous rectification transistor M2 according to the pulse signal.

FIGS. 2A to 2C are operation waveform diagrams of the DC/DC converter 100r. A positive direction of a coil current I_{L} is a direction in which the coil current I_{L} flows to the output capacitor C1. FIG. 2A illustrates a waveform at the time of heavy loading and FIG. 2B illustrates a waveform at the time of light loading. As illustrated in FIG. 2B, if an output current I_{OUT} decreases, the coil current I_{L} flows in a reverse direction and becomes negative as hatched. The negative coil current I_{L} flows to a ground via the synchronous rectification transistor M2 and power is wastefully consumed.

To prevent efficiency from being lowered due to the reverse flow of the coil current I_{L}, a discontinuous mode is used at the time of the light loading. FIG. 2C is an operation waveform diagram of the discontinuous mode. In the discontinuous mode, if the reverse flow of the coil current I_{L} is detected, both the switching transistor M1 and the synchronous rectification transistor M2 are turned off to enter a high impedance state. As a result, the negative coil current I_{L} is interrupted and the efficiency is improved.

The present inventors have examined the discontinuous mode and have recognized the following problems as a result thereof. FIGS. 3A to 3C illustrate operation waveforms of the discontinuous mode. The controller detects the reverse flow of the coil current I_{L} using a comparator. Specifically, the coil current I_{L} is detected using a current detection circuit and the comparator compares a detection value of the coil current I_{L} with a threshold I_{TH} slightly larger than zero. If crossing of the detection value and the threshold is detected, a ZEROCOMP signal is asserted. In addition, when the ZEROCOMP signal is asserted, the synchronous rectification transistor M2 is turned off. A delay τ_{DET} shows a detection delay of the current detection circuit and the comparator and τ_{DRV} shows a propagation delay of a driver of the synchronous rectification transistor M2.

As illustrated in FIG. 3A, the threshold I_{TH} is designed in consideration of the detection delay τ_{DET} and the propagation delay τ_{DRV} and an inclination of the coil current I_{L}, such that the synchronous rectification transistor M2 is turned off at an ideal zero crossing point where the coil current I_{L} is completely zero. However, the detection delay τ_{DET} and the propagation delay τ_{DRV} are not constant but varied.

For example, when a filter circuit is used for detecting the coil current I_{L} in the current detection circuit, the detection delay τ_{DET} is varied due to a variation in components of the filter circuit. Or, in an application to which the synchronous rectification transistor M2 or the driver is externally attached, the variation in the propagation delay τ_{DRV} becomes remarkable.

As illustrated in FIG. 3B, when a total delay (τ_{DET}+τ_{DRV}) is smaller than a design value of FIG. 3A, the synchronous rectification transistor M2 is turned off while the positive coil current I_{L} flows. As a result, the coil current I_{L} flows to a freewheel diode (body) connected in parallel to the synchronous rectification transistor M2 and the efficiency is lowered.

As illustrated in FIG. 3C, when the total delay (τ_{DET}+τ_{DRV}) is larger than the design value of FIG. 3A, the negative coil current I_{L} flows and the efficiency is lowered. The same problems occur even in boosting and step-up/down DC/DC converters.

### SUMMARY OF THE INVENTION

The present invention has been made in view of the above circumstances and a general purpose thereof is to provide a synchronous rectification DC/DC converter in which efficiency is improved.

An embodiment of the present invention relates to a controller of a synchronous rectification DC/DC converter. The controller includes a pulse modulator structured to generate a pulse signal, such that an output signal of the DC/DC converter approaches a target value; a reverse flow detection circuit structured to, when a detection value of a coil current of the DC/DC converter crosses a threshold for zero crossing, assert a reverse flow detection signal and structured to turn off a synchronous rectification transistor of the DC/DC converter; and an optimizer structured to control an operation parameter of the reverse flow detection circuit, on the basis of the pulse signal.

The present inventors have performed an examination and have recognized that a cycle (or an interval and a length of a high impedance section of a discontinuous mode) of a pulse signal generated in a light loading state and efficiency of the DC/DC converter have a correlation. Therefore, an operation parameter of the reverse flow detection circuit is changed on the basis of the pulse signal, so that the efficiency can be improved.

The operation parameter of the reverse flow detection circuit includes various parameters that can adjust a delay time from crossing of the detection value of the coil current and the threshold to turning-off of the synchronous rectification transistor.

The optimizer may control the operation parameter of the reverse flow detection circuit, on the basis of a cycle of the pulse signal. The optimizer may control the operation parameter of the reverse flow detection circuit, such that a cycle of the pulse signal approaches a maximum value. A maximum point of the efficiency is matched with a maximum point of the cycle of the pulse signal or exists near the maximum point. Therefore, the operation parameter is changed to increase the cycle of the pulse signal, so that the efficiency can be improved. Or, the operation parameter of the reverse flow detection circuit may be controlled such that the cycle of the pulse signal is included in a predetermined range.

The optimizer may be activated at an interval longer than a cycle of the pulse signal. The optimizer is stopped in an interval period, so that consumption power can be reduced.

The optimizer may include a cycle counter structured to measure the cycle of the pulse signal.

The cycle counter may measure the cycle of the pulse signal twice and stop an operation until next measurement. The optimizer may perform first measurement using an operation parameter in an immediately previous idle period, perform second measurement using an operation parameter obtained by changing the operation parameter used in the first measurement by a predetermined step, and determine an operation parameter used in a next idle period, on the basis of a comparison result of two measurement values.

In the optimizer, switching of upstate and downstate may be enabled, in the upstate, the operation parameter used in the second measurement may be obtained by changing the operation parameter used in the first measurement in a first direction, and in the downstate, the operation parameter used in the second measurement may be obtained by changing the operation parameter used in the first measurement in a second direction to be a direction opposite to the first direction.

When a second measurement value is larger than a first measurement value, the operation parameter may be changed in the first direction more than a second operation parameter and the optimizer may be set to the upstate, and when the second measurement value is smaller than the first measurement value, the operation parameter may be changed in the second direction more than the second operation parameter and the optimizer may be set to the upstate.

The reverse flow detection circuit may include a comparator structured to compare the detection value of the coil current with the threshold and a variable delay circuit structured to delay output of the comparator and to generate the reverse flow detection signal. The optimizer may be structured to control a delay time of the variable delay circuit.

The reverse flow detection circuit may include a comparator structured to compare the detection value of the coil current with the threshold. The optimizer may be structured to control an offset voltage of the comparator.

The reverse flow detection circuit may include a comparator structured to compare the detection value of the coil current with the threshold. The optimizer may be structured to control the threshold.

The detection value of the coil current may be generated on the basis of a voltage across an inductor of the DC/DC converter.

In this case, the coil current is detected using a series resistor of the inductor. However, a filter is used together to extract a voltage drop across the series resistor. According to this embodiment, the efficiency can be suppressed from being lowered due to a variation in the time constant of a filter or the inductance of the inductor.

The detection value of the coil current may be generated on the basis of a voltage drop across a sense resistor provided in series to an inductor of the DC/DC converter. The detection value of the coil current may be generated on the basis of a voltage across the synchronous rectification transistor of the DC/DC converter.

The controller may be monolithically integrated into a semiconductor substrate.

Another embodiment of the present invention relates to a synchronous rectification DC/DC converter. The DC/DC converter includes the controller described above.

Other embodiment of the present invention also relates to a synchronous rectification DC/DC converter. The DC/DC converter includes a pulse modulator structured to generate a pulse signal, such that an output signal of the DC/DC converter approaches a target value; a current detection circuit structured to generate a detection value of a coil current of the DC/DC converter; a reverse flow detection circuit structured to assert a reverse flow detection signal, when the detection value of the coil current crosses a threshold for zero crossing; a driver structured to drive a switching transistor and a synchronous rectification transistor of the DC/DC converter, on the basis of the pulse signal, and structured to turn off the synchronous rectification transistor of the DC/DC converter, when the detection signal is asserted; and an optimizer structured to control an operation parameter of the reverse flow detection circuit, on the basis of the pulse signal.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a synchronous rectification step-down DC/DC converter;

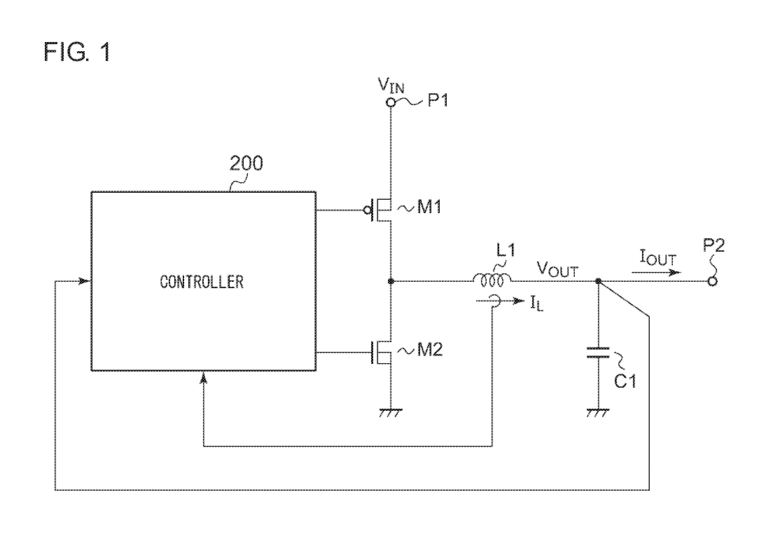

FIGS. 2A to 2C are operation waveform diagrams of the DC/DC converter;

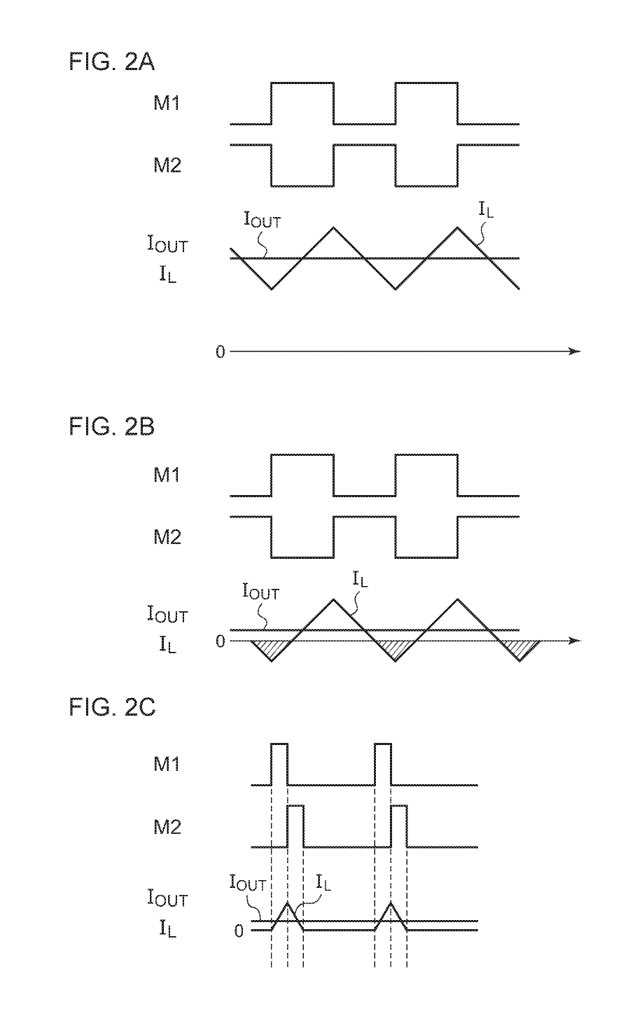

FIGS. 3A to 3C are diagrams illustrating operation waveforms of a discontinuous mode;

FIG. 4 is a block diagram of a DC/DC converter according to an embodiment;

FIG. 5 is a circuit diagram illustrating a configuration example of a reverse flow detection circuit and an optimizer;

FIGS. 6A to 6D are diagrams illustrating examples of efficiency, a delay amount τ_{D}, a cycle T_{P} of a pulse signal, and a coil current I_{L} at timing when a synchronous rectification transistor is turned off;

FIG. 7 is a time chart illustrating an example of an operation of the optimizer;

FIG. 8 is a flowchart illustrating an optimization algorithm of the optimizer;

FIG. 9 is a circuit diagram illustrating a configuration example of a controller according to the embodiment;

FIG. 10 is a diagram illustrating an example of an electronic apparatus including the DC/DC converter according to the embodiment; and

FIGS. 11A and 11B are diagrams illustrating modifications of current detection.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, a “state in which a member A is connected to a member B” includes a state in which the member A is indirectly connected to the member B via another member, not substantially affecting a state of electric connection thereof or impairing a function and an effect achieved by coupling thereof, in addition to a state in which the member A is physically and directly connected to the member B.

Similarly, a “state in which a member C is provided between the member A and the member B” includes a state in which the member A is indirectly connected to the member C via another member or the member B is indirectly connected to the member C via another member, not substantially affecting a state of electric connection thereof or impairing a function and an effect achieved by coupling thereof, in addition to a state in which the member A is directly connected to the member C or the member B is directly connected to the member C.

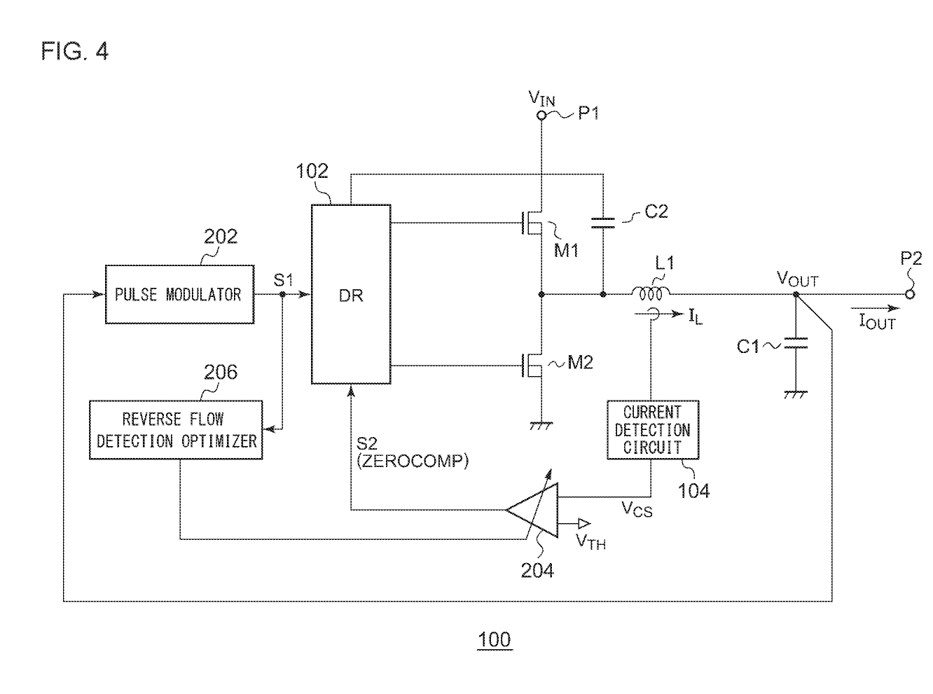

FIG. 4 is a block diagram of a DC/DC converter 100 according to an embodiment. In this embodiment, it is assumed that the DC/DC converter 100 is a step-down DC/DC converter (buck converter). The DC/DC converter 100 receives a DC input voltage V_{IN} by an input terminal P1, generates an output voltage V_{OUT} stabilized to a predetermined target value V_{OUT(REF)}, and supplies the output voltage V_{OUT} to a load connected to an output terminal P2.

A switching transistor M1, a synchronous rectification transistor M2, an inductor L1, and an output capacitor C1 configure an output circuit of the buck converter.

A pulse modulator 202 generates a pulse signal S1 such that an output signal (output voltage V_{OUT}) of the DC/DC converter 100 approaches the target value V_{OUT(REF).} A driver 102 switches the switching transistor M1 and the synchronous rectification transistor M2, according to the pulse signal S1. In this embodiment, the switching transistor M1 is an N-channel MOSFET and a bootstrap circuit (not illustrated in the drawings) including a bootstrap capacitor C2 is provided to turn on the switching transistor M1. The switching transistor M1 may be a P-channel MOSFET. In this case, the bootstrap circuit is not necessary.

A current detection circuit 104 generates a current detection signal V_{CS} showing a detection value of a coil current I_{L} flowing to the inductor L1.

If the detection value V_{CS} of the coil current I_{L} of the DC/DC converter 100 crosses a threshold V_{TH} for zero crossing, a reverse flow detection circuit 204 asserts a reverse flow detection signal S2 (referred to as ZEROCOMP) and turns off the synchronous rectification transistor M2 of the DC/DC converter 100. The threshold V_{TH} is set to a positive value near zero.

A reverse flow detection optimizer 206 (hereinafter, simply referred to as the optimizer 206) controls an operation parameter of the reverse flow detection circuit 204, on the basis of the pulse signal S1. In other words, the reverse flow detection circuit 204 is configured such that at least one operation parameter affecting a delay time τ from crossing of the detection value V_{CS} of the coil current I_{L} and the threshold V_{TH} to turning-off of the synchronous rectification transistor M2 is varied.

The above is the configuration of the DC/DC converter 100. Next, an operation of the DC/DC converter 100 will be described.

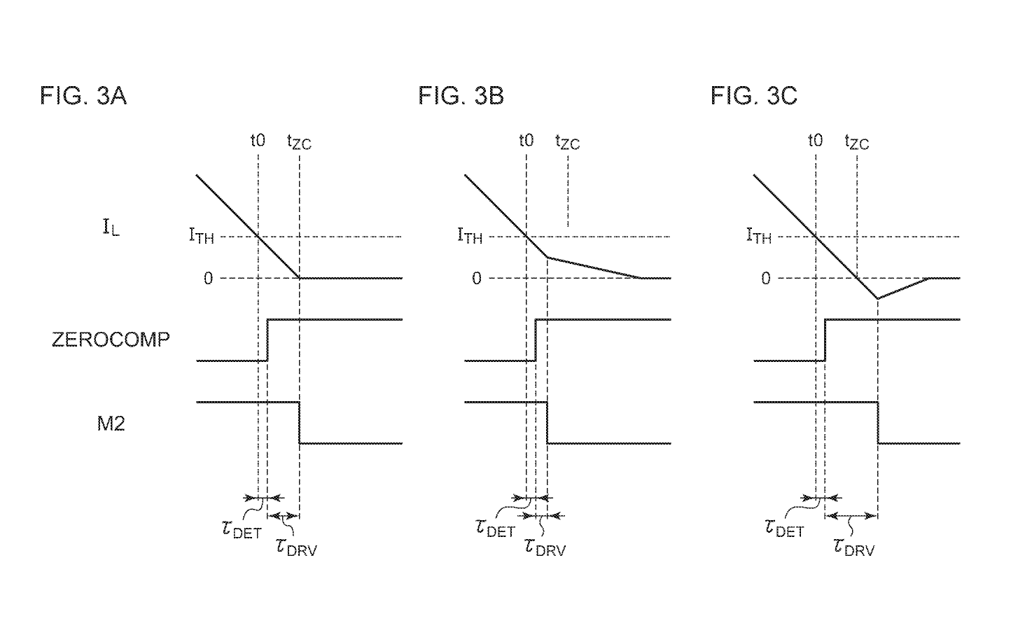

As described with reference to FIGS. 3A to 3C, efficiency at the time of light loading in the DC/DC converter 100 depends on timing when the synchronous rectification transistor M2 is turned off. According to an examination result from the present inventors, a cycle (interval of the pulse signal S1) of the pulse signal S1 takes a maximum value at optimal timing t_{ZC} of FIG. 3A or timing near the optimal timing. As illustrated in FIG. 3B, when turning-off timing is earlier than the optimal timing of FIG. 3A, the cycle of the pulse signal Si decreases. In contrast, as illustrated in FIG. 3C, even when the turning-off timing is later than the optimal timing of FIG. 3A, the cycle of the pulse signal S1 decreases.

In other words, the operation parameter is changed to increase the cycle of the pulse signal S1, so that the turning-off timing of the synchronous rectification transistor M2 can be caused to approach the timing t_{ZC} when the coil current I_{L} crosses zero, and efficiency can be improved.

The present invention extends to various apparatuses and circuits grasped as the block diagram of FIG. 4 or a circuit diagram or derived from the above description and is not limited to a specific configuration. Hereinafter, more concrete control method, configuration, and embodiment will be described to help understanding of the nature of the invention or a circuit operation and to clarify them, not to narrow a range of the present invention.

The optimizer 206 measures a cycle T_{P} of the pulse signal S1 and controls the operation parameter of the reverse flow detection circuit 204, on the basis of a measurement value of the cycle T_{P}. Preferably, the optimizer 206 may control the operation parameter of the reverse flow detection circuit 204, such that the cycle T_{P} of the pulse signal S1 approaches a maximum value.

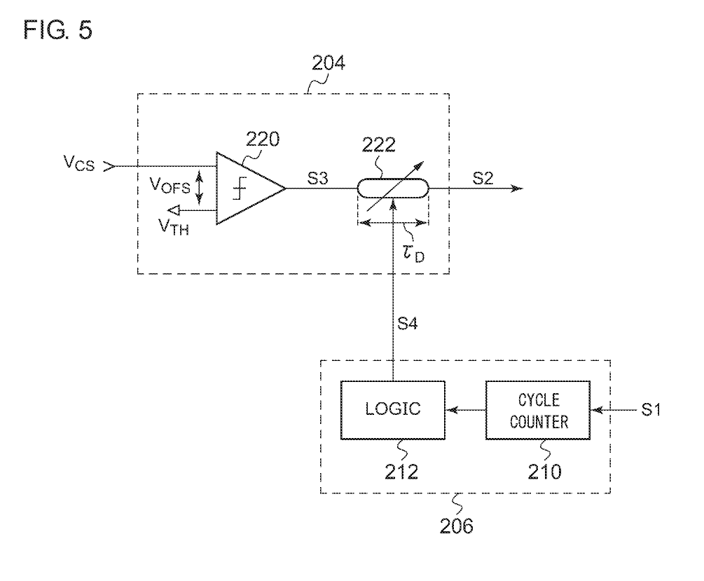

FIG. 5 is a circuit diagram illustrating a configuration example of the reverse flow detection circuit 204 and the optimizer 206. In this configuration, the operation parameter of the reverse flow detection circuit 204 corresponds to a delay amount of the reverse flow detection signal S2. For example, the reverse flow detection circuit 204 includes a comparator 220 and a variable delay circuit 222. The comparator 220 compares the current detection signal V_{CS} and the threshold voltage V_{TH} and generates a comparison signal S3 showing a comparison result. The variable delay circuit 222 gives a variable delay τ_{D} to the comparison signal S3 and generates the reverse flow detection signal S2. The variable delay circuit 222 may be configured integrally with the comparator 220.

The configuration of the variable delay circuit 222 is not limited in particular and known technology may be used. For example, the variable delay circuit 222 may include a CR circuit, configure at least one of a capacitor and a resistor by a variable element, and change a capacity value or a resistance value to change a delay amount. Or, the variable delay circuit 222 may include a plurality of delay elements connected in series and a selector selecting one of a plurality of taps provided in outputs of the plurality of delay elements.

The optimizer 206 controls the delay amount TD of the variable delay circuit 222. The optimizer 206 includes a cycle counter 210 and a logic unit 212. The cycle counter 210 measures the cycle T_{P} of the pulse signal S1. The measurement of the cycle of the pulse signal S1 includes measurement of a cycle of a signal equal to the pulse signal S1 or a signal in an inverse relation with the pulse signal S1, in addition to the measurement of the cycle of the pulse signal S1. The logic unit 212 changes a control signal S4 to designate the delay amount τ_{D} of the variable delay circuit 222, such that the measured cycle T_{P} increases.

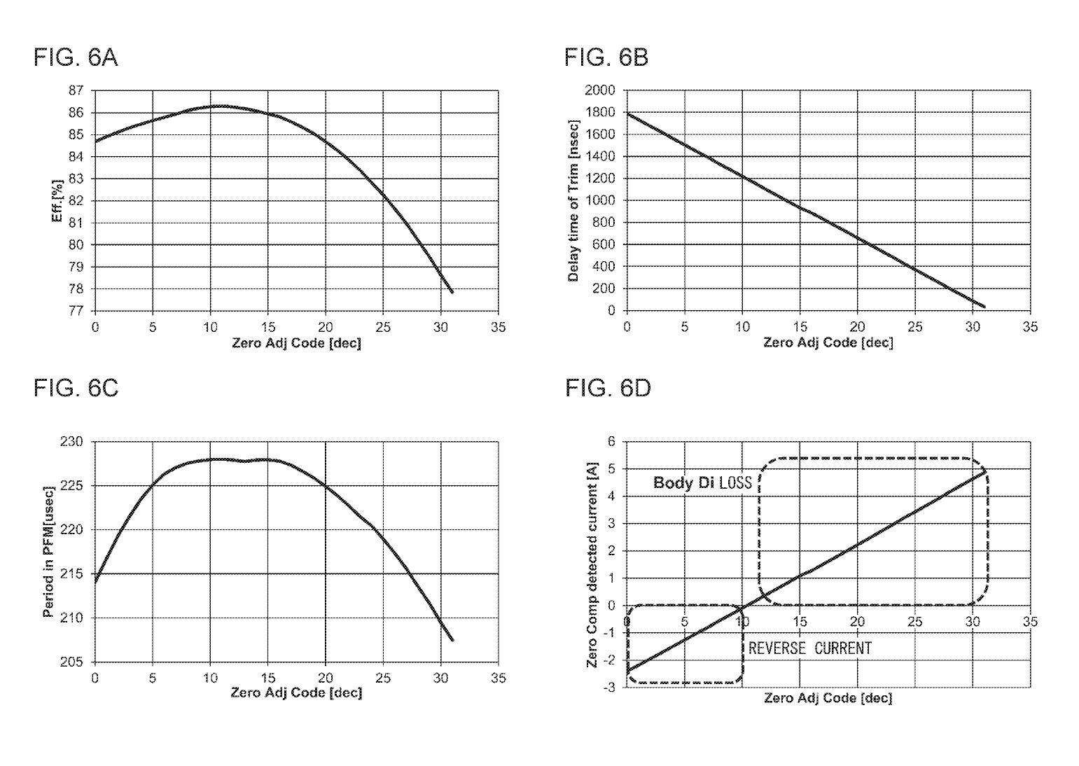

FIGS. 6A to 6D are diagrams illustrating examples of the efficiency, the delay amount τ_{D}, the cycle T_{P} of the pulse signal S1, and the coil current I_{L} at timing when the synchronous rectification transistor M2 is turned off. ZeroAdjCode of a horizontal axis shows a value of the control signal S4. In this example, as illustrated in FIG. 6B, the delay amount m decreases when the value of the control signal S4 increases. Referring to FIG. 6D, when the value of the control signal S4 is 10, the synchronous rectification transistor M2 is turned off at timing when the coil current I_{L} is zero. Referring to FIG. 6A, a maximum point of the efficiency exists near S4=10. If FIGS. 6A and 6C are compared, it is known that the control signal S4 in which the efficiency is maximized and the control signal S4 in which the cycle T_{P} of the pulse signal S1 is maximized are substantially matched with each other or approach each other.

Therefore, the control signal S4 is adjusted to increase the cycle T_{P} of the pulse signal S1, so that the efficiency can be raised.

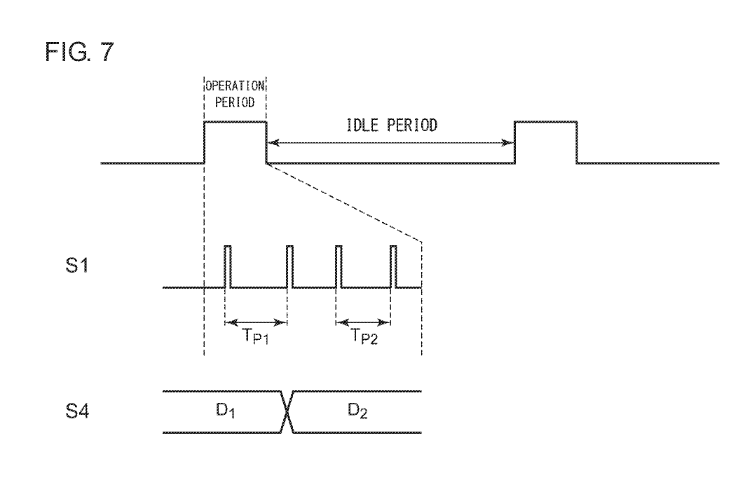

Next, a control example of the optimizer 206 will be described. FIG. 7 is a time chart illustrating an example of an operation of the optimizer 206. If the optimizer 206 is always operated, consumption power increases. Therefore, the optimizer 206 is activated intermittently at an interval longer than the cycle of the pulse signal S1 and stops the operation during a period of the remaining interval. As a result, the consumption power can be suppressed from increasing.

During a first operation period, the cycle counter 210 changes the control signal S4 (operation parameter) and measures cycles of the pulse signal S1 for each operation parameter. In addition, the cycle counter 210 determines a value of the control signal S4 in a next idle period, on the basis of a magnitude relation of the measured cycles. For example, during the first operation period, the cycle counter 210 may change the control signal S4 by two values D₁ and D₂ and measure corresponding cycles T_{P1} and T_{P2}. The first measurement may be performed using an operation parameter in an immediately previous idle period. In addition, the second measurement may be performed using an operation parameter obtained by changing the operation parameter used in the first measurement by a predetermined step. In addition, an operation parameter used in a next idle period may be determined on the basis of a comparison result of the two measurement values T_{P1} and T_{P2}.

In the optimizer 206, upstate and downstate can be switched. In the upstate, the operation parameter used in the second measurement is obtained by changing (for example, increasing) the operation parameter used in the first measurement in a first direction. In the downstate, the operation parameter used in the second measurement is obtained by changing (for example, decreasing) the operation parameter used in the first measurement in a second direction to be a direction opposite to the first direction.

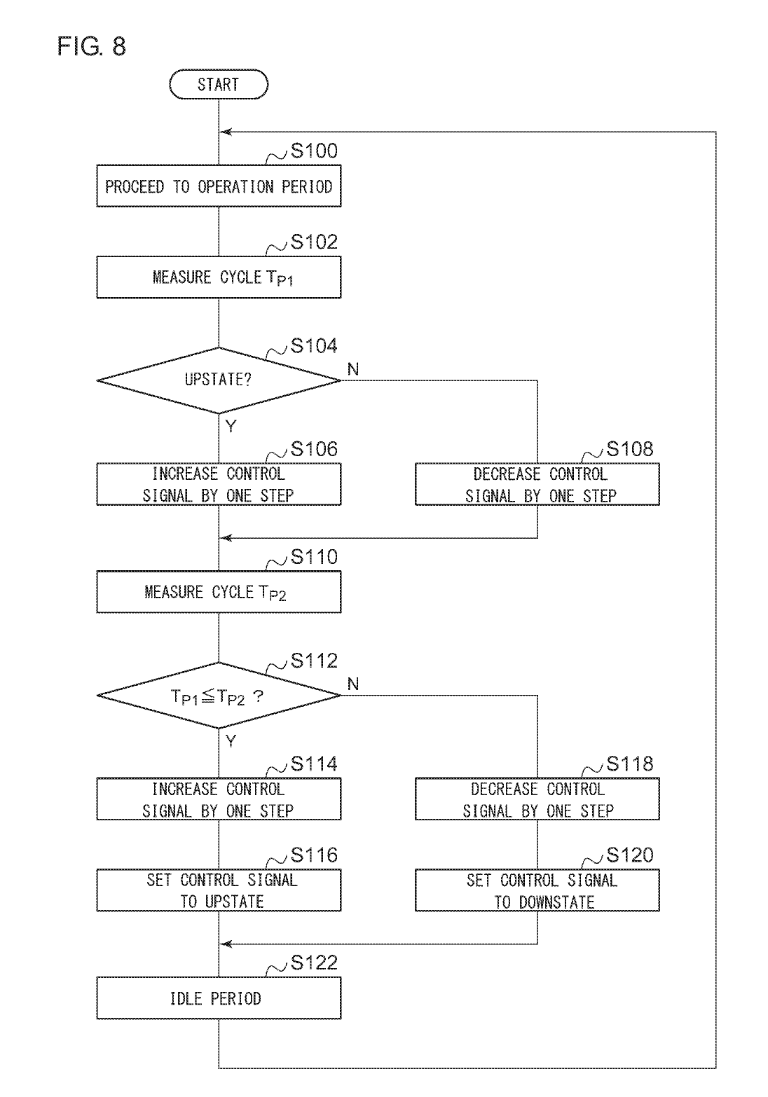

FIG. 8 is a flowchart illustrating an optimization algorithm of the optimizer 206. When the optimization algorithm proceeds to an operation period (S100), the cycle T_{P1} is measured in a state of the control signal S4 in an immediately previous idle period (S102). In addition, in the case of the upstate (Y of S104), the control signal S4 increases (increments) by one step (S106). In contrast, in the case of the downstate (N of S104), the control signal S4 decreases (decrements) by one step (S108). Next, the cycle T_{P2} is measured (S110).

In the case of T_{P1}≦T_{P2} (Y of S112), the control signal S4 is increased by one step (S114) and is set to the upstate (S116). In the case of T_{P1}>T_{P2} (N of S112), the control signal S4 is decreased by one step (S118) and is set to the downstate (S120). In addition, steps S114 and S118 may be omitted. In step S112, in the case of T_{P1}=T_{P2}, the optimization algorithm proceeds to step S118.

Then, the optimization algorithm proceeds to a next idle period (S122). If a predetermined interval passes, the optimization algorithm returns to step 5100.

The above is the control of the optimizer 206. According to the control, when the cycle of the pulse signal Si is different from the maximum value, the cycle can be caused to approach the maximum value and the cycle can be maintained at almost the maximum value.

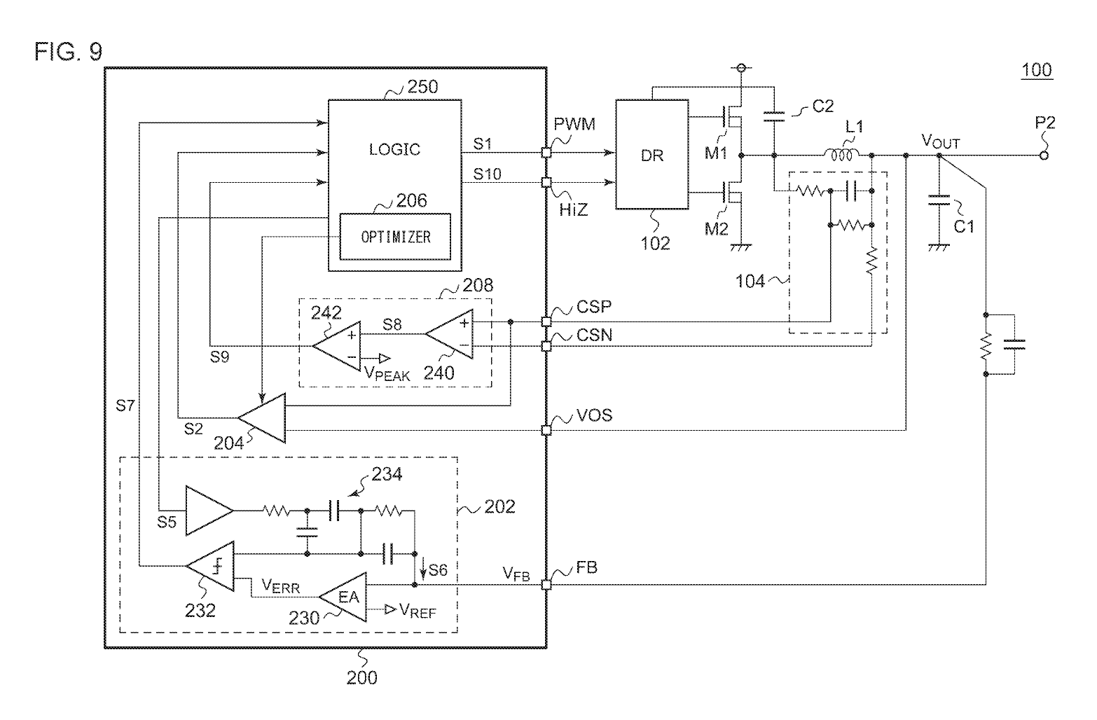

FIG. 9 is a circuit diagram illustrating a configuration example of a controller 200 according to the embodiment. The controller 200 is a functional integrated circuit (IC) that mainly includes the pulse modulator 202, the reverse flow detection circuit 204, and the optimizer 206 of FIG. 4 and is monolithically integrated on a semiconductor substrate.

A feedback signal V_{FB} according to an output voltage V_{OUT} is input to a feedback (FB) terminal of the controller 200. The pulse modulator 202 generates the pulse signal S1 such that the feedback signal V_{FB} approaches a reference voltage V_{REF}. A configuration and a control method of the pulse modulator 202 are not limited in particular and known technology may be used.

For example, the pulse modulator 202 includes an error amplifier 230, a comparator 232, and a ripple superimposition circuit 234. The ripple superimposition circuit 234 receives a pulse signal S5 according to the pulse signal S1 and superimposes a ripple signal S6 on an input side of the error amplifier 230. The error amplifier 230 amplifies an error of the feedback signal V_{FB} and the reference voltage V_{REF} and generates an error signal V_{ERR}. The comparator 232 compares the feedback signal V_{FB} on which ripples are superimposed with the error signal V_{ERR} and generates a pulse signal S7.

The current detection circuit 104 detects the coil current I_{L} flowing to the inductor L1, on the basis of a voltage across the inductor L1. For the current detection circuit 104, known technology may be used. An output of the current detection circuit 104 is input to a CSP terminal and a CSN terminal of the controller 200.

A voltage of one end of the inductor L1 is input to a VOS terminal of the controller 200. The reverse flow detection circuit 204 compares a voltage of the CSP terminal and a voltage of the VOS terminal and generates the reverse flow detection signal S2.

A peak current detection circuit 208 is provided to regulate an on time of the switching transistor M1 at the time of light loading. The peak current detection circuit 208 includes an amplifier 240 that amplifies a potential difference of the CSP terminal and the CSN terminal and a peak detection comparator 242 that compares an output signal S8 of the amplifier 240 with a threshold V_{PEAK}. An output S9 of the peak detection comparator 242 is asserted (for example, a high level) when the coil current I_{L} reaches a peak value I_{PEAK} corresponding to the voltage V_{PEAK}.

A logic circuit 250 generates the pulse signal S1 and generates a control signal S10 to execute an operation in a discontinuous mode, on the basis of the pulse signal S7, the reverse flow detection signal S2, and the peak detection signal S9. If the reverse flow detection signal S2 is asserted, the logic circuit 250 asserts the control signal S10. If the control signal S10 is asserted, the driver 102 turns off the switching transistor M1 and the synchronous rectification transistor M2. In the logic circuit 250, in a light loading state, an on time of the switching transistor M1 is regulated according to the peak detection signal S9 and an on state of the switching transistor M1 is maintained until the peak detection signal S9 is asserted. As a result, energy accumulated in the inductor L1 in the light loading state can be regulated.

The optimizer 206 can be configured as a part of the logic circuit 250.

The above is the configuration of the controller 200. According to the controller 200, the DC/DC converter 100 can be operated with high efficiency. The driver 102 or the switching transistor M1 and the synchronous rectification transistor M2 may be integrated into the controller 200.

### (Application)

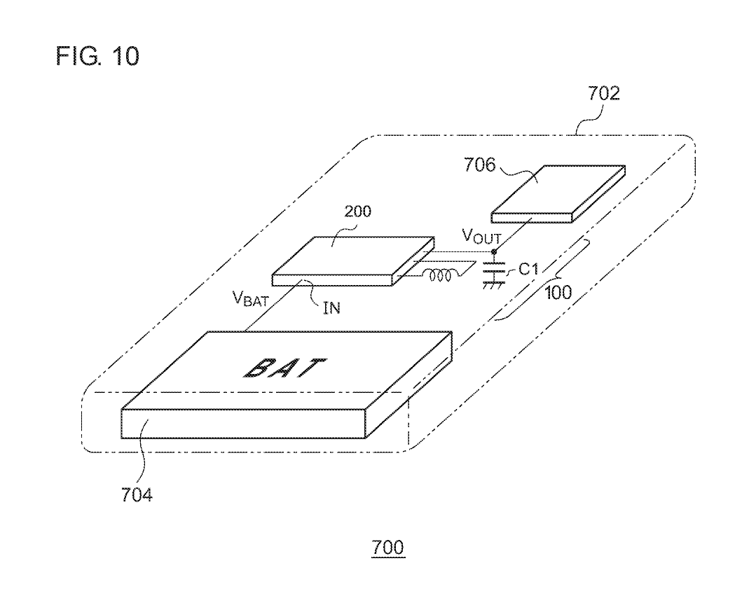

FIG. 10 is a diagram illustrating an example of an electronic apparatus 700 including the DC/DC converter 100 according to the embodiment. The electronic apparatus 700 is a battery-driven device such as a mobile phone terminal, a digital camera, a digital video camera, a tablet terminal, and a portable audio player. The electronic apparatus 700 includes a casing 702, a battery 704, a microprocessor 706, and the DC/DC converter 100. The DC/DC converter 100 receives a battery voltage V_{BAT} (=V_{IN}) from the battery 704 by the input terminal thereof and supplies the output voltage V_{OUT} to the microprocessor 706 connected to the output terminal thereof.

The DC/DC converter 100 in which the high efficiency operation is enabled is mounted on the battery-driven electronic apparatus 700, so that an operation time of the electronic apparatus 700 can be increased.

The present invention has been described on the basis of the embodiment. However, it should be understood by those skilled in the art that the embodiment is only exemplary, various modifications can be made in combinations of the individual components or the individual processes, and the modifications are also included in a range of the present invention. Hereinafter, the modifications will be described.

### (First Modification)

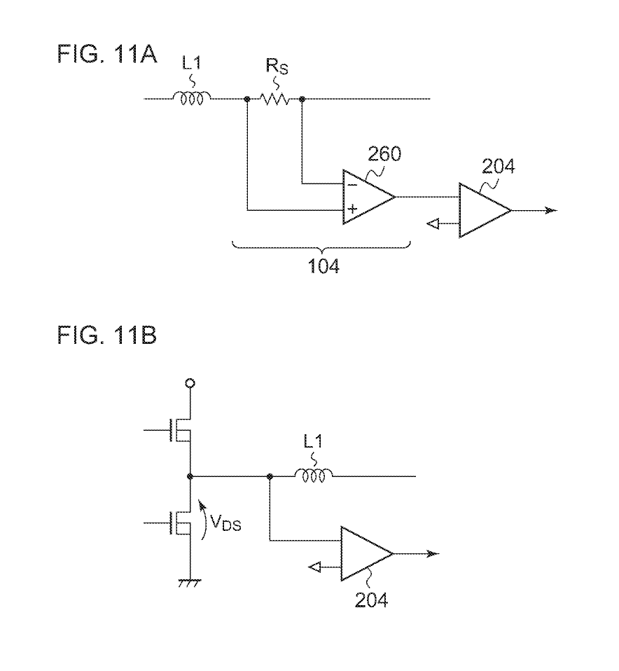

FIGS. 11A and 11B are diagrams illustrating modifications of current detection. In FIG. 11A, a sense resistor R_{S} is provided in series to the inductor L1. An amplifier 260 amplifies a voltage drop across the sense resistor R_{S} and generates a detection value of the coil current I_{L}.

In FIG. 11B, the coil current I_{L} is detected using on resistance of the synchronous rectification transistor M2. That is, the detection value of the coil current I_{L} is generated on the basis of a voltage V_{DS} across the synchronous rectification transistor M2 of the DC/DC converter 100.

### (Second Modification)

The operation parameter of the reverse flow detection circuit 204 is not limited to the delay time. For example, in FIG. 5, the threshold voltage V_{TH} input to the comparator 220 may be varied and the threshold voltage V_{TH} may be controlled by the optimizer 206. Or, an input offset voltage of the comparator 220 may be varied and an offset voltage V_{OFS} may be controlled by the optimizer 206.

### (Third Modification)

The control algorithm of the optimizer 206 is not limited to the above example and a known maximum value search algorithm may be adopted. For example, simply, the operation parameter may be swept and a point where the pulse cycle T_{P} is maximized may be searched. The optimizer 206 may control the operation parameter of the reverse flow detection circuit 204, such that the cycle T_{P} of the pulse signal S1 is included in a predetermined target range.

### (Fourth Modification)

In the embodiment, the optimization is performed by the optimizer 206 during the operation of the DC/DC converter 100. However, the present invention is not limited thereto. Before a load operates immediately after the DC/DC converter 100 starts, a calibration period may be provided and the operation parameter may be optimized during the calibration period.

### (Fifth Modification)

In the embodiment, the operation parameter of the reverse flow detection circuit 204 is controlled on the basis of the cycle T_{P} of the pulse signal S1. However, the present invention is not limited thereto. For example, the operation parameter may be controlled on the basis of a length of an off time of the switching transistor M1 or a period in which the switching transistor M1 and the synchronous rectification transistor M2 enter a high impedance state. That is, the operation parameter can be controlled on the basis of the various characteristics (the cycle, the frequency, the on time, the off time, and the high impedance period) of the pulse signal S1 correlated with the efficiency.

### (Sixth Modification)

In the embodiment, the step-down converter is described as the example. However, the present invention is applicable to a synchronous rectification boosting or step-up/down converter.

While the preferred embodiments of the present invention have been described using specific terms, such description is for illustrative purposes only, and it is to be understood that changes and variations may be made without departing from the spirit or scope of the appended claims.

What is claimed is:

1. A controller of a synchronous rectification DC/DC converter, the controller comprising:
a pulse modulator structured to generate a pulse signal, such that an output signal of the DC/DC converter approaches a target value;
a reverse flow detection circuit structured to, when a detection value of a coil current of the DC/DC converter crosses a threshold for zero crossing, assert a reverse flow detection signal and structured to turn off a synchronous rectification transistor of the DC/DC converter; and
an optimizer structured to control an operation parameter of the reverse flow detection circuit, on the basis of the pulse signal.

2. The controller according to claim 1, wherein
the optimizer is structured to control the operation parameter of the reverse flow detection circuit, on the basis of a cycle of the pulse signal.

3. The controller according to claim 1, wherein
the optimizer is structured to control the operation parameter of the reverse flow detection circuit, such that a cycle of the pulse signal approaches a maximum value.

4. The controller according to claim 1, wherein
the optimizer is activated at an interval longer than a cycle of the pulse signal.

5. The controller according to claim 2, wherein
the optimizer includes a cycle counter structured to measure the cycle of the pulse signal.

6. The controller according to claim 5, wherein
the cycle counter is structured to measure the cycle of the pulse signal twice and stops an operation until next measurement, and
the optimizer is structured to perform first measurement using an operation parameter in an immediately previous idle period, to perform second measurement using an operation parameter obtained by changing the operation parameter used in the first measurement by a predetermined step, and to determine an operation parameter used in a next idle period, on the basis of a comparison result of two measurement values.

7. The controller according to claim 6, wherein
in the optimizer, switching of upstate and downstate is enabled,
in the upstate, the operation parameter used in the second measurement is obtained by changing the operation parameter used in the first measurement in a first direction, and
in the downstate, the operation parameter used in the second measurement is obtained by changing the operation parameter used in the first measurement in a second direction to be a direction opposite to the first direction.

8. The controller according to claim 7, wherein
when a second measurement value is larger than a first measurement value, the operation parameter is changed in the first direction more than a second operation parameter and the optimizer is set to the upstate, and
when the second measurement value is smaller than the first measurement value, the operation parameter is changed in the second direction more than the second operation parameter and the optimizer is set to the upstate.

9. The controller according to claim 1, wherein
the reverse flow detection circuit includes a comparator which compares the detection value of the coil current with the threshold and a variable delay circuit which delays an output of the comparator and generates the detection signal, and
the optimizer controls a delay time of the variable delay circuit.

10. The controller according to claim 1, wherein
the reverse flow detection circuit includes a comparator structured to compare the detection value of the coil current with the threshold, and
the optimizer is structured to control an offset voltage of the comparator.

11. The controller according to claim 1, wherein
the reverse flow detection circuit includes a comparator structured to compare the detection value of the coil current with the threshold, and
the optimizer controls the threshold.

12. The controller according to claim 1, wherein
the detection value of the coil current is generated on the basis of a voltage across an inductor of the DC/DC converter.

13. The controller according to claim 1, wherein
the detection value of the coil current is generated on the basis of a voltage drop across a sense resistor provided in series to an inductor of the DC/DC converter.

14. The controller according to claim 1, wherein
the detection value of the coil current is generated on the basis of a voltage across the synchronous rectification transistor of the DC/DC converter.

15. The controller according to claim 1, wherein the controller is monolithically integrated on a semiconductor substrate.

16. A synchronous rectification DC/DC converter comprising the controller according to claim 1.

17. An electronic apparatus comprising the DC/DC converter according to claim 16.

18. A synchronous rectification DC/DC converter comprising:
a pulse modulator structured to generate a pulse signal, such that an output signal of the DC/DC converter approaches a target value;
a current detection circuit structured to generate a detection value of a coil current of the DC/DC converter;
a reverse flow detection circuit structured to assert a detection signal, when the detection value of the coil current crosses a threshold for zero crossing;
a driver which structured to drive a switching transistor and a synchronous rectification transistor of the DC/DC converter, on the basis of the pulse signal, and to turn off the synchronous rectification transistor of the DC/DC converter, when the detection signal is asserted; and
an optimizer structured to control an operation parameter of the reverse flow detection circuit, on the basis of the pulse signal.

19. A control method for a synchronous rectification DC/DC converter, the control method comprising:
generating a pulse signal, such that an output signal of the DC/DC converter approaches a target value;
generating a detection value of a coil current of the DC/DC converter;
asserting a detection signal, when the detection value of the coil current crosses a threshold for zero crossing;
driving a switching transistor and a synchronous rectification transistor of the DC/DC converter, on the basis of the pulse signal;
turning off the synchronous rectification transistor of the DC/DC converter, when the detection signal is asserted; and
controlling a response speed when the detection signal is generated, on the basis of the pulse signal.

20. The control method according to claim 19, further comprising:
measuring a cycle of the pulse signal,
wherein, in the controlling of the response speed, the response speed is controlled such that the cycle of the pulse signal increases.
